(19) United States
(12) Patent Application Publication
(10) Pub. No.: US 2010/0033696 A1
(43) Pub. Date: Feb. 11, 2010

(54) METHOD AND APPARATUS FOR PRODUCING AN ELEMENT HAVING AT LEAST ONE FREEFORM SURFACE HAVING A HIGH ACCURACY OF FORM AND A LOW SURFACE ROUGHNESS

(75) Inventors: Thure BOEHM, Aalen (DE); Stefan Burkart, Heidenheim (DE); Hans-Juergen Mann, Oberkochen (DE); Danny Chan, Esslingen (DE); Holger Maltor, Aalen (DE)

Correspondence Address: SUGHRUE MION, PLLC, 2100 PENNSYLVANIA AVENUE, N.W., SUITE 800, WASHINGTON, DC, 20037, US

(73) Assignee: Carl Zeiss SMT AG, Oberkochen (DE)

(21) Appl. No.: 12/563,766

(22) Filed: Sep. 21, 2009

Related U.S. Application Data
(63) Continuation of application No. PCT/EP2008/053398, filed on Mar. 20, 2008.

(30) Foreign Application Priority Data
Mar. 21, 2007 (DE) 102007013563.9

(51) Int. Cl. G03B 27/68; B24B 1/00; B24B 41/06; B32B 3/00

(52) U.S. Cl. 355/52; 451/42; 451/390; 428/141

(57) ABSTRACT

A method for producing an element having at least one arbitrarily freely formed surface (freeform surface) having a high accuracy of form and a low surface roughness. The freeform surface is obtained by at least one first processing step with a shaping material processing method in which at least an approximation to the desired freeform surface (target form) is effected, and at least one second step with a material processing method that smooths the surface, wherein at least during the second processing step of the smoothing material processing, the element (1) to be processed is elastically stressed by force introduction such that the freeform surface to be smoothed is processed by smoothing processes for spherical, plane or aspherical surfaces. A corresponding apparatus includes a mount receiving the element to be processed and a smoothing tool smoothing the freeform surface, wherein the receptacle has at least one actuator (6) for exerting a force on the element to be processed, such that the element to be processed can be elastically stressed into an intermediate shape (2″), such that the freeform surface to be smoothed can be processed with the smoothing tool by smoothing processes for spherical, plane or aspherical surfaces.

This is a Continuation of International Application PCT/EP2008/053398, with an international filing date of Mar. 20, 2008, which was published under PCT Article 21(2) in German, and the complete disclosure of which, including amendments, is incorporated into this application by reference.

### FIELD OF AND BACKGROUND OF THE INVENTION

The present invention relates to a method for producing an element having at least one arbitrarily freely formed surface (freeform surface) having a high accuracy of form and a low surface roughness, and to an apparatus for smoothing a freeform surface.

High performance illumination and projection objectives for illuminating and imaging the structures of a reticule onto a semiconductor component are used for microlithography for producing electrotechnical devices having extremely small structure sizes. In order to be able to obtain the corresponding imaging accuracies in the nanometers range, it is necessary to use optical elements such as lenses, mirrors and the like having a high accuracy of form and low surface roughnesses and to produce them accordingly. In the material processing methods available for this purpose, a distinction is drawn between shaping methods which maintain the surface roughness and those which result in a roughening of the surface during processing. Unfavorably, precisely the methods which enable high degrees of material removal, such as e.g. grinding or milling, are unfavorable with regard to the surface roughness since they lead to a severe roughening of the surface. Accordingly, after processing methods of this type, which are necessary, however, for processing the optical elements in tenable times, smoothing steps or smoothing processes are carried out, by which the roughenings caused by the shaping are eliminated again. However, since the smoothing steps usually in turn bring about an alteration of the form as a result of material removal, the form errors introduced thereby have to be corrected again in form correction steps. Accordingly, the result is a process chain comprising a sequence of form correction and smoothing steps until the desired accuracy of form and surface roughness are attained.

On account of the further increasing requirements made of the performance of the microlithography objectives, in addition to the spherical surface forms of the optical elements with spherical segment surfaces and aspherical yet rotationally symmetrical optical surfaces deviating from said spherical form, non-rotationally symmetrical optical surfaces arbitrarily freely formed, so-called freeform surfaces, are increasingly also required in order to ensure the corresponding imagings. In the case of freeform surfaces of this type, however, the problem arises that, in contrast to the spherical surfaces and aspherical, rotationally symmetrical surfaces, there are no suitable smoothing processes available which make it possible to set a surface roughness that remains constant over the entire surface in conjunction with a high accuracy of form at the corresponding surface.

DE 10 331 390 A1 discloses a method in which an optical element having two opposite spherical surfaces is pressed into an aspherical forming shell and is subsequently processed spherically. In the stress-relieved state, the processed surface relaxes from the spherical shape into an aspherical form.

An adaptation of the surface to be processed to the shaping tool is also known from JP 2000 084 838 A. Here semiconductor components having a non-planar surface are adapted to the planar shaping tool by corresponding deformation, such that the corresponding surface can be processed by the shaping tool.

### DISCLOSURE OF THE INVENTION

### Object of the Invention

It is an object of the present invention to provide a method and an apparatus which make it possible to produce elements, in particular optical elements, such as mirrors, lenses and the like, which have at least one arbitrarily freely formed surface, a so-called freeform surface, which satisfies extremely stringent requirements made of high accuracy of form and low surface roughness. In particular, elements of this type are intended to be suitable for being used as optical elements for microlithography objectives with the corresponding accuracy and roughness requirements. Furthermore, the intention is to enable the method to be applied in a simple manner and the apparatus to be produced and operated in a simple manner, and overall to enable effective production of the corresponding elements. Furthermore, it is also an object to provide corresponding optical elements and projection exposure apparatuses for microlithography comprising corresponding optical elements.

### Technical Solution

This object is achieved, according to various formulations, by a method, an apparatus, an optical element, and a projection exposure apparatus as recited e.g. in the enclosed independent claims. The dependent claims relate, inter alia, to advantageous configurations.

The inventors have recognized that the object mentioned above can be achieved by at least dividing the processing steps in two, to be precise on the one hand into a shaping step and on the other hand into a smoothing step. Furthermore, according to the invention the procedure is such that, in the smoothing step in particular, a stress or resultant elastic deformation of the element to be processed is brought about, which enables processing by means of known smoothing processes for spherical, plane or aspherical, in particular rotationally symmetrical, surfaces. It is ensured in this way that shaping methods with a high degree of material removal can be used in the shaping step, with the result that short processing times are ensured. The roughnesses possibly introduced as a result of this are then eliminated in a subsequent smoothing process, wherein the stress or deformation of the element to be processed establishes an intermediate form that makes it possible to use smoothing processes for spherical, almost spherical, plane or aspherical, rotationally symmetrical surfaces. In this case, the inventors have recognized that the deformation or stress of the element to be processed that was previously used for forming aspherical optical surfaces can be modified in a novel manner for achieving the objective mentioned above.

Unlike in the above-described method in DE 10 331 390 A1, according to the method of the present invention, firstly an arbitrarily formed workpiece is brought to a form approximated to the desired freeform surface by any shaping methods whatever, in order that the surface to be processed is subsequently brought to a spherical, almost spherical, plane or rotationally symmetrical shape by force action. This intermediate form is then smoothed in the second processing step. Accordingly, in the method according to the present invention, unlike in the known method according to DE 10 331 390 A1, the shaping is not carried out in a stressed, deformed state, but rather in particular the smoothing of a freeform surface already present.

What is essential in the present invention, therefore, is that the processing is divided into two independent, separate steps, namely on the one hand the shaping step and on the other hand the smoothing step, and that an arbitrarily freely formed, non-rotationally symmetrical surface can be fashioned in the shaping step, which surface can then be correspondingly set in terms of the surface roughness in the subsequent smoothing step. At the same time, the method according to the invention ensures that the method can be carried out in a simple manner since the element to be processed has to be clamped into a processing apparatus only during the second processing step, that is to say the smoothing step, in which apparatus actuators act on the opposite side with respect to the surface to be processed, in such a way that, from the arbitrarily freely formed surface to be processed, which is usually not rotationally symmetrical, a rotationally symmetrical or ideally spherical or almost spherical surface is produced by elastic deformation or stress, which surface can then be processed in a simple manner.

In the case of the force introduction for stressing or deforming the element to be processed, mechanically, piezoelectrically, pneumatically and/or hydraulically acting actuators can be provided with the result that both tensile and compressive forces can act on the optical element. This has the effect that the surface to be processed can both be bulged outward and pressed inward.

The force introduction or the distribution of the actuators at the opposite side with respect to the surface to be processed can be such that the entire element to be processed can be influenced by the actuators, that is to say that the actuators are distributed over the entire side opposite to the surface to be processed.

In this case, the actuators can be arranged in or at the receptacle of the processing apparatus in such a way that the actuators in a manner adjacent to one another cover the entire receptacle. In particular, the actuators can be arranged in an array in rows and columns.

The required tensile and/or compressive forces can be determined by a preceding simulation calculation from the sought target form of the surface and the surface contour set in the first processing step. For this purpose, it is merely necessary to determine in advance what intermediate form the surface to be processed is intended to assume during the second processing step, that is to say the smoothing step.

The first and second processing steps, that is to say the shaping step and the smoothing step, can be run through repeatedly one after another in the method according to the invention, wherein different material processing methods can be used in particular during the individual processing steps in each cycle in order thus to progressively approximate to the target form with the accuracy of form and surface roughness sought.

The second processing step, that is to say the smoothing of the freeform surface, can be followed by a third processing step, in which a material processing is performed which enables a slight correction of the form whilst simultaneously maintaining the surface roughness. Corresponding methods can be for example ion beam methods, ion beam figuring (IBF) or magnetorheological processing methods (MRF). Although these methods merely have only a small degree of material removal, they have the advantage that they do not lead to a roughening of the surface. Accordingly, they are suitable for slight form adaptations after smoothing or setting of the surface roughness has already been effected.

Said third processing step can be effected after stress relief of the element to be processed, that is to say cancellation of the corresponding force introduction. In particular, the third processing step can be preceded by a measuring step for measuring or assessing the surface obtained with regard to accuracy of form and surface roughness, as moreover can also be carried out during, before or after every other processing step of the method according to the invention, for example by means of interferometric measurements.

In particular, corresponding devices for monitoring and measuring the surface, which make it possible intermittently or continuously to compare the surface achieved with the target form, can be provided directly at the processing tools.

During the first processing step or steps, that is to say the shaping steps, processing methods with a relatively large degree of material removal are used in order to ensure effective production of the desired element having a freeform surface. Suitable methods here include methods which have a degree of material removal of the order of magnitude of at least 50 nm, preferably at least 100 nm, in particular at least 20 μm, per processing step. Possible methods here include grinding or milling methods, in particular five-axis milling, honing or lapping. It should be taken into consideration here that the removal values and methods used should not be regarded as absolute, but rather are to be understood in relative terms depending on the surface quality sought and the tenable outlay and the area of use and merely indicate starting points or preferred ranges. It is also evident from this that material removal per processing step can be taken to mean either the material removal when passing over the surface once, e.g. during milling, or the total removal when passing over the surface repeatedly in one process step.

During the first processing step, the element to be processed can be either in a stressed state or in a stress-relieved state.

In the second processing steps, that is to say the smoothing methods, material processing methods with a small degree of material removal of the order of magnitude of at most 1 μm, in particular at most 100 nm, per processing step are used, which enable in particular a low surface roughness of the order of magnitude of ≦1 nm, preferably ≦0.1 nm RMS roughness. The statements made regarding the removal values in the first processing step are applicable here in the same way.

In particular, the method involves using material processing methods which make it possible to produce a freeform surface having an accuracy of form in which the root mean square deviation from the target form is ≦10 nm, preferably ≦1 nm. At the same time, the surface roughness is intended to be values of the RMS roughness, in which the root mean square deviations from a central line are employed, of ≦1 nm or ≦0.1 nm. The measuring method used can include all measuring methods known to the person skilled in the art for determining surface forms and roughnesses, in particular standard methods defined in corresponding DIN or ISO standards, preferably interferometric measurements.

The method according to the invention can be used in such a way that, as early as in the design of the corresponding element, that is to say for example of an optical element for a microlithography objective, the corresponding processing steps, that is to say in particular the stress or deformation during the second processing step, are concomitantly taken into account as boundary conditions.

The present invention correspondingly comprises an apparatus for carrying out the method, wherein the apparatus has at least one receptacle for mounting the element to be processed and a smoothing tool for the smoothing processing of the freeform surface. According to the invention, at least one actuator for exerting a tensile and/or compressive force on the element to be processed is provided in the receptacle, such that the element to be processed can be elastically stressed into an intermediate form. The freeform surface to be smoothed can correspondingly be processed by means of a smoothing tool for spherical, plane or aspherical surfaces, which is readily possible with smoothing tools that are correspondingly present, wherein the surface to be processed is provided by the intermediate form.

The present invention likewise relates to an optical element processed or produced by the method according to the invention or the apparatus according to the invention.

Such an optical element is distinguished by an accuracy of form of the freeform surface within the range of ≦10 nm root mean square (RMS) and/or a surface roughness within the range of ≦1 nm RMS roughness.

Preferably, the accuracy of form can be ≦1 nm root mean square, and the surface roughness can have ≦0.1 nm RMS roughness.

Since the freeform surface which is processed according to the invention and has corresponding accuracy of form and roughness values is preferably an optically active surface, the method according to the invention or the corresponding apparatus or the optical elements produced thereby are particularly suitable for use in projection exposure apparatuses for microlithography. Consequently, this invention likewise also relates to a corresponding projection exposure apparatus and in particular a projection objective or an illumination system of a projection exposure apparatus comprising a corresponding optical element in particular for EUV microlithography with light or generally electromagnetic radiation in the range of the extreme ultraviolet wavelength range.

### BRIEF DESCRIPTION OF THE FIGURES

Further advantages, characteristics and features of the present invention will become clear from the following detailed description of an exemplary embodiment with reference to the accompanying drawings, in which, in a purely schematic manner here

FIG. 1 shows a lateral sectional view of an optical element to be processed;

FIG. 2 shows a sectional view of the optical element from FIG. 1 after a first processing step;

FIG. 3 shows a sectional view of the optical element from FIGS. 1 and 2 in an apparatus for carrying out the second processing step; and

FIG. 4 shows a sectional view of the completed optical element from the preceding figures.

### EXEMPLARY EMBODIMENT

FIG. 1 shows a lateral sectional view of a semifinished product of an optical element 1, such as, for example, of an optical lens composed of a corresponding glass material. In addition to the exemplary embodiment of an optical lens 1 shown, however, other optical elements such as mirrors or the like are also conceivable. Overall, the method is not just restricted to optical elements, but rather given correspondingly suitable materials can be employed for all components appertaining to microengineering in which a high accuracy of form combined with a very low surface roughness have to be present.

The semifinished product for an optical lens 1 as shown in FIG. 1 has a spherical optical surface 2 curved convexly outward. The opposite side 3 is embodied in plane fashion. A corresponding semifinished product for an optical element 1 can be produced by a process in casting technology, for example. However, mechanical processing steps may also already have been run through for producing the semifinished product as present in FIG. 1.

The spherical surface 2, which corresponds to a spherical segment, is intended to have an arbitrarily freely formed surface instead of the spherical form, in which case the deviations from the spherical surface 2 can be realized by arbitrary elevations or depressions or recesses. Although the deviations from the spherical form can be very small, they are reproduced in an excessively exaggerated manner in order to illustrate the method principle in the schematic illustrations that follow.

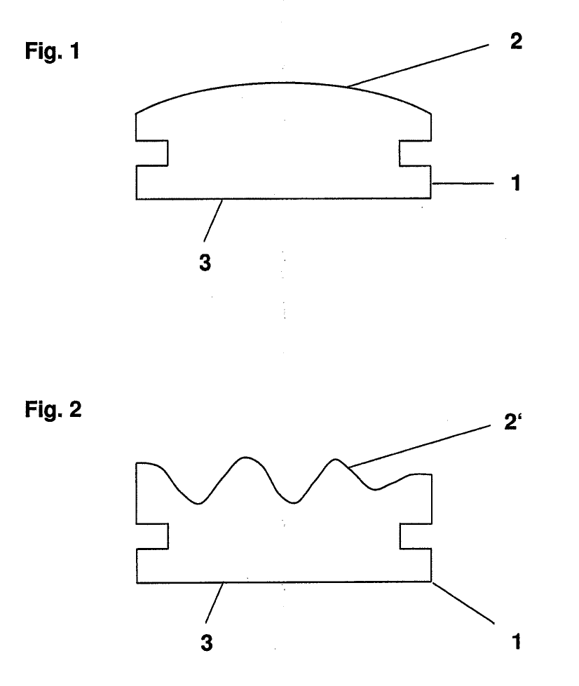

FIG. 2 shows the optical element 1 in an intermediate stage after a first processing step, in which the optical element 1 and in particular the optical surface 2 are approximated to the desired freeform surface having an arbitrary surface contour by means of shaping material processing methods. The surface 2′ produced as a result may have been produced for example by processing using a five-axis milling machine. The topography of the surface 2′ has already been approximated to the freeform surface to be obtained. However, the methods that obtain a corresponding degree of material removal for producing the desired form in a short time produce a surface roughness that usually does not correspond to the requirements made of corresponding optical elements of a microlithography objective. The surface 2′ of the intermediate product in FIG. 2 must accordingly also be subjected to a smoothing process in order to set the desired surface quality or surface roughness. Accordingly, the set structure of the surface 2′ has been approximated to the target form only insofar as a corresponding material removal by the required smoothing process has already been taken into account and has accordingly not yet been removed from the surface 2′.

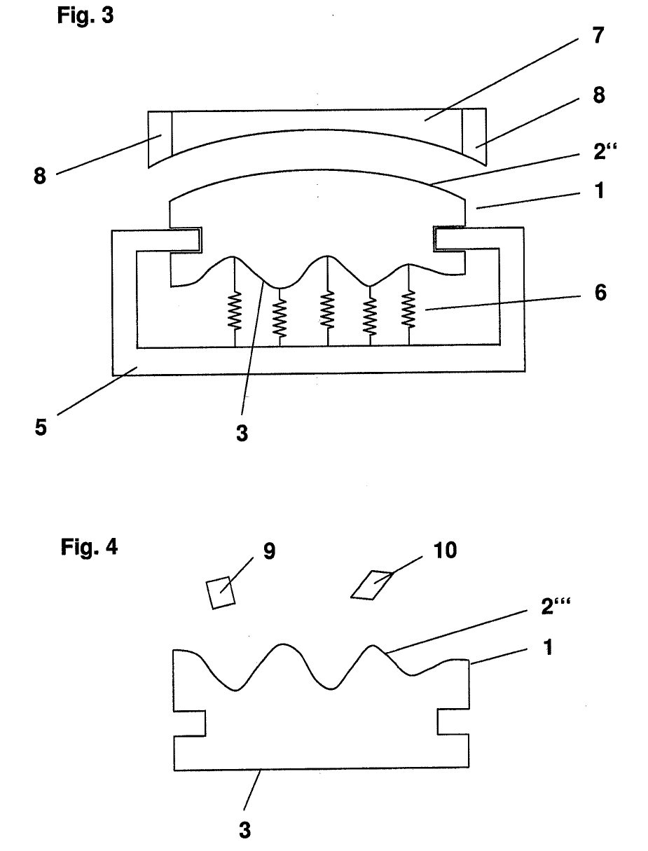

Since the arbitrarily formed surface 2′ of the optical element 1, on account of its non-rotationally symmetrical form, cannot be smoothed with the sufficient quality by customary smoothing processes, in a second processing step the optical element 1 is accommodated in a clamping frame 5 of a corresponding processing apparatus. The clamping frame 5 has a multiplicity of actuators 6, which are illustrated as spring elements for applying tensile and/or compressive stresses in FIG. 3. The actuators 6 can be realized by any suitable device whatever, such as, for example, mechanical elements, such as spring elements, piezoelectric elements, pneumatic or hydraulic actuators, such as mini cylinders and the like. The actuators 6 act on the opposite side 3 with respect to the surface 2 to be processed and bring about an elastic stressing of the optical element 1 into an intermediate state 2″ in which the surface 2″ ideally assumes a spherical, that is to say spherical-segment-shaped, form. Instead of an essentially ideal spherical form, the surface 2″ of the optical element 1 can also assume an almost spherical shape or a rotationally symmetrical, aspherical form in the intermediate state. All that is essential is that a suitable smoothing process which produces a uniform roughness over the entire surface 2″ without grinding or polishing tracks or the like is present for the surface form of the intermediate state. In the exemplary embodiment shown in FIG. 3, the freeform surface 2′ has been put into a stressed state, in which the surface 2″ to be processed has a spherical form, after the shaping first processing step for the second work step, which brings about the smoothing, in accordance with FIG. 3. As already mentioned, however, instead of a spherical surface 2″, a rotationally symmetrical, aspherical surface 2″ would also be conceivable as long as suitable smoothing tools are available.

In the case of the spherical surface 2″, provision is made for example of a full shell tool 7 for a full shell smoothing process, in which the smoothing tool 7 bears on the spherical surface 2″ over the whole area and can perform a uniform smoothing of the surface.

After the second processing step, that is to say the smoothing process, has been carried out, the surface 2″ can be examined with regard to its surface quality by a measuring device 8, which can for example be arranged on the processing tool 7 or be integrated in the latter. In this way it is possible to ascertain continuously or by short interruptions during the smoothing process whether the required surface roughnesses have already been set.

After the conclusion of the second processing step, that is to say of the smoothing process, a renewed pass through the two processing steps can be effected if for example the measuring device 8 has ascertained that although the surface roughness has been set in a corresponding manner, a small form error is still present. On the one hand, therefore, a further shaping first processing step for producing an intermediate product in accordance with FIG. 2 and on the other hand a further second processing step for smoothing the surface will be run through. This can be done as often as until the accuracy of form of the optical surface 2 and the surface roughness of the same surface lie within the required tolerance ranges.

If it is ascertained after one or a plurality of second processing steps that both the accuracy of form and the surface roughness lie within the range sought, then the optical element 1 is removed from the clamping frame 5 after the last second processing step, with the result that the optical element 1 can relax. In this case, as is shown in FIG. 4, the plane side 3 will revert to its original form again, while the surface 2″, which was spherical in the stressed state, now has the target form, that is to say the arbitrarily freely formed freeform surface 2′″ having a corresponding accuracy of form and surface roughness. In one possible variant, instead of a plane side 3, an arbitrarily formed surface can be provided at this side of the optical element 1 to be processed.

If the surface 2′″ still has deviations with regard to the desired target form, then it is possible, finally, to carry out a third processing step with a material processing method that achieves a degree of material removal while at the same time maintaining the surface roughness set. In this respect, ion beam methods, ion beam figuring (IBF), or magnetorheological methods, such as MRF (magnetorheological finishing), are examples. This is illustrated by the schematic tool 9 in FIG. 4. The methods for shaping while maintaining the surface roughness have only very low material removal rates, however, with the result that these can only be used for slight corrections of the surface in order to achieve the target form.

The surface 2′″ can in turn be examined or measured by a corresponding measuring apparatus 10, similar to the measuring apparatus 8 after or during the second processing step, during or after the third processing step, in order to ascertain whether the desired form has been set. This can, of course, also be carried out after the first or during the first processing step for shaping. Interferometric methods, in particular, can be used here as measuring methods.

If, however, it is ascertained after the second processing step for example that the surface 2′″ in the stress-relieved state corresponds to the target stipulations, then a third processing step can be dispensed with.

Although the present invention has been described in detail on the basis of the exemplary embodiment illustrated, it is clearly evident to the person skilled in the art that the invention is not just restricted to an embodiment of this type. Rather, modifications and changes, in particular with regard to omitting individual features presented or combining the features presented in a different manner, are conceivable without departing from the overall invention sought to be covered by the appended claims.

The invention is therefore distinguished in particular by the following non-restrictive features:
1. Method for producing an element having at least one arbitrarily freely formed surface (freeform surface) having a high accuracy of form and a low surface roughness, in particular an optical element having an optical freeform surface for an objective for microlithography, wherein the freeform surface is obtained by at least one first processing step with a shaping material processing method in which at least an approximation to the desired freeform surface (target form) is effected, and at least one second step with a material processing method that smooths the surface, wherein at least during a second processing step of the smoothing material processing, the element (1) to be processed is elastically stressed by force introduction in such a way that the freeform surface (2) to be smoothed can be processed by smoothing processes for spherical, plane or aspherical surfaces.
2. Method according to feature 1, wherein the freeform surface of the element (1) to be processed, during the smoothing in a second processing step, is in an intermediate form (2″) which is rotationally symmetrical and/or spherical, almost spherical or plane.
3. Method according to feature 1 or 2, wherein the force introduction is effected by tensile and/or compressive forces applied in spatially distributed fashion in particular at an opposite side (3)—with respect to the surface to be processed—of the element to be processed.
4. Method according to feature 3, wherein the forces are applied hydraulically, pneumatically, piezoelectrically or by mechanical actuators (6).
5. Method according to feature 3 or 4, wherein an optimum form of the freeform surface to be processed is determined for the second processing step and the required forces are determined by a simulation calculation.
6. Method according to any of the preceding features, wherein first and second processing steps are run through multiply one after another, wherein different material processing methods can be used in particular during the individual processing steps.
7. Method according to any of the preceding features, wherein a third, in particular final, processing step is effected after a second processing step, in which a form correction is carried out whilst maintaining the surface roughness.
8. Method according to feature 7, wherein ion beam methods and/or magnetorheological processing methods are used as roughness-maintaining surface processing during the third processing step.
9. Method according to feature 7 or 8, wherein the element to be processed is in a stress-relieved state during the third processing step.
10. Method according to any of the preceding features, wherein the shaping methods used during the first processing step are methods with a large degree of material removal, in particular of the order of magnitude of more than 50 nm, in particular more than 100 nm, preferably more than 20 μm, per processing step, in particular at least one from the group comprising grinding, milling, honing and lapping.
11. Method according to any of the preceding features, wherein the element to be processed is in a stress-relieved state or in a stressed, intermediate state during a first processing step.
12. Method according to any of the preceding features, wherein the surface to be processed, after the first processing step, is an arbitrarily freely formed surface which, in particular, is not rotationally symmetrical.
13. Method according to any of the preceding features, wherein the smoothing methods used during the second processing step are methods with a small degree of material removal and a low surface roughness, in particular of the order of magnitude of less than 1 μm, in particular less than 100 nm, per processing step, in particular polishing and/or finishing.
14. Method according to any of the preceding features, wherein the accuracy of form of the completely processed freeform surface is in the range of less than or equal to 10 nm, preferably less than or equal to 1 nm root mean square (RMS) and/or the surface roughness is in the range of less than or equal to 1 nm, preferably less than or equal to 0.1 nm RMS roughness.
15. Method according to any of the preceding features, wherein the processing in the first, second and/or third processing steps is taken into account as a boundary condition in the design of the freeform surface.
16. Method according to any of the preceding features, wherein the surface to be processed is measured, in particular measured interferometrically, before, during and/or after the first, second and third processing steps.
17. Apparatus for smoothing an arbitrarily freely formed surface (freeform surface) of an element having a high accuracy of form and a low surface roughness, in particular an optical element having an optical freeform surface for an objective for microlithography, preferably in accordance with the method according to any of the preceding features, comprising a receptacle for mounting the element to be processed and a smoothing tool for the smoothing processing of the freeform surface, wherein the receptacle has at least one actuator (6) for exerting a tensile and/or compressive force on the element (1) to be processed, such that the element to be processed can be elastically stressed into an intermediate form (2″), such that the freeform surface to be smoothed can be processed with the smoothing tool by smoothing processes for spherical, plane or aspherical surfaces.
18. Apparatus according to feature 17, wherein the receptacle is configured such that the surface to be processed of the intermediate form is a spherical, almost spherical, plane or rotationally symmetrical surface.
19. Apparatus according to feature 17 or 18, wherein a multiplicity of actuators (6) are provided in a manner distributed over the receptacle, such that forces can be applied in a manner distributed over the element to be processed.
20. Apparatus according to feature 19, wherein an array of actuators (6) is provided, which actuators are arranged in rows and columns and preferably in a manner directly adjacent to one another cover the entire receptacle.
21. Apparatus according to any of features 17 to 20, wherein the actuators comprise mechanical, piezoelectric, pneumatic and/or hydraulic actuating elements.
22. Optical element, produced according to the method according to any of features 1 to 16.
23. Optical element having at least one arbitrarily freely formed surface (freeform surface), wherein the accuracy of form of the freeform surface is in the range of ≦10 nm root mean square (RMS) and/or the surface roughness is in the range of ≦1 nm RMS roughness.
24. Optical element according to feature 23, wherein the accuracy of form is ≦1 nm root mean square.
25. Optical element according to either of features 23 and 24, wherein the surface roughness is ≦0.1 nm RMS roughness.
26. Optical element according to any of features 23 to 25, wherein the freeform surface is an optically active surface.
27. Projection exposure apparatus for microlithography comprising an optical element according to any of features 22 to 27.
28. Projection exposure apparatus according to feature 27, wherein the projection exposure apparatus is set up for EUV (extreme ultraviolet) microlithography.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the enclosed claims, and equivalents thereof.

1. Method for producing an element having at least one freeform surface having a high accuracy of form and a low surface roughness, comprising:
at least one first processing step with a shaping material processing method in which at least a target form approximating the freeform surface is effected, and
at least one second processing step with a material processing method that smooths the surface,
wherein, at least during the smoothing material processing of the second processing step, the element is elastically stressed by introducing at least one force while the surface is processed by at least one smoothing process designed for spherical, plane or aspherical surfaces.

2. Method according to claim 1,
wherein the surface of the element being processed, during the smoothing in the second processing step, is in an intermediate shape which is at least one of rotationally symmetrical, substantially rotationally symmetrical and spherical, substantially spherical, plane or substantially plane.

3. Method according to claim 1,
wherein the force introduction is effected by at least one of tensile and compressive forces applied spatially distributed

4. Method according to claim 3,
wherein the forces are applied hydraulically, pneumatically, piezoelectrically or by mechanical actuators.

5. Method according to claim 3,
further comprising a simulation calculation for determining the forces required to produce an optimum form for the freeform surface being processed in the second processing step.

6. Method according to claim 1,
further comprising performing the first and second processing steps a plurality of times one after another subsequently to the at least one first processing step and the at least one second processing step, wherein the material processing methods in the subsequent first processing steps are the same as or differ from the material processing method of the at least one first processing step, and are the same as or differ from each other.

7. Method according to claim 1,
further comprising at least one third processing step after the at least one second processing step, in which third processing step a form correction is carried out while maintaining the surface roughness.

8. Method according to claim 7,
wherein the third processing step comprises at least one of an ion beam method and a magnetorheological processing method as roughness-maintaining surface processing.

9. Method according to claim 7,
wherein the element is in a stress-relieved state during the third processing step.

10. Method according to claim 1,
wherein the shaping method of the first processing step removes at least on the order of magnitude of more than 50 nm of material and comprises at least one of grinding, milling, honing and lapping.

11. Method according to claim 1,
wherein the element is in a stress-relieved state or in an intermediate state of stress during the at least one first processing step.

12. Method according to claim 1,
wherein the surface, after the at least one first processing step is not rotationally symmetrical.

13. Method according to claim 1,
wherein the smoothing method of the second processing step removes no more than on the order of magnitude of less than 1 μm of material and comprises at least one of polishing and finishing.

14. Method according to claim 1,
wherein at least one of (i) an accuracy of form of the freeform surface following completion of the processing steps is no larger than 10 nm root mean square (RMS) and (ii) the surface roughness is no larger than 1 nm RMS roughness.

15. Method according to claim 1,
further comprising setting the processing in at least one of the first and the second processing steps as a boundary condition in design of the freeform surface.

16. Method according to claim 1,
further comprising measuring the surface to be processed interferometrically at least one of: before, during and after the first and the second processing steps.

17. Apparatus for smoothing a freeform surface of an element having a high accuracy of form and a low surface roughness, comprising:
a receptacle configured to mount the element, and
a smoothing tool configured to smooth the freeform surface,
wherein the receptacle has at least one actuator exerting at least one of a tensile and a compressive force on the element, such that the element is elastically stressed into an intermediate shape, and wherein the smoothing tool is configured to perform at least one smoothing processes for at least one of a spherical, plane or aspherical surface.

18. Apparatus according to claim 17,
wherein the receptacle is configured to place and hold the surface corresponding to the intermediate shape in at least one of a spherical, substantially spherical, plane, substantially plane, rotationally symmetrical, or substantially rotationally symmetrical surface.

19. Apparatus according to claim 17,
wherein the receptacle comprises further actuators distributed over the receptacle, such that the forces are applied distributed over the element.

20. Apparatus according to claim 19,
wherein the actuators form an array, which actuators are arranged in rows and columns.

21. Apparatus according to claim 17,
wherein the actuator comprises at least one of mechanical, piezoelectric, pneumatic and hydraulic actuating elements.

22. Optical element having at least one freeform surface, comprising:
at least one of: (i) an accuracy of form of the freeform surface no larger than 10 nm root mean square (RMS), and a surface roughness no larger than 1 nm RMS roughness.

23. Optical element according to claim 22,
wherein the accuracy of form is ≦1 nm root mean square.

24. Optical element according to claim 22,
wherein the surface roughness is ≦0.1 nm RMS roughness.

25. Optical element according to claim 22,
wherein the freeform surface is an optically active surface.

26. Projection exposure apparatus for microlithography comprising an optical element according to claim 22.

27. Projection exposure apparatus according to claim 26,
configured for EUV (extreme ultraviolet) microlithography.

28. Method according to claim 3, wherein the forces are applied to the element on a surface opposite the freeform surface.

29. Method according to claim 7, wherein the third processing step is a single, final processing step.

30. Method according to claim 29,
further comprising setting the processing in the third processing step as a boundary condition in design of the freeform surface.

31. Method according to claim 29,
further comprising measuring the surface interferometrically at least one of: before, during and after the third processing step.

32. Method according to claim 10,
wherein the shaping method of the first processing step removes at least on the order of magnitude of more than 20 μm.

33. Method according to claim 13,
wherein the smoothing method of the second processing step removes no more than on the order of magnitude of less than 100 nm.

34. Method according to claim 14,
wherein at least one of (i) the accuracy of form is no larger than 1 nm RMS and (ii) the surface roughness is no larger than 0.1 nm RMS roughness.

35. Apparatus according to claim 20,
wherein the actuators are positioned adjacent to one another so as to extend over an entire area of the receptacle that confronts a surface of the element opposite the freeform surface.
